(19) United States
(12) Patent Application Publication
(10) Pub. No.: US 2025/0232462 A1
(43) Pub. Date: Jul. 17, 2025

(54) METHOD FOR ASCERTAINING AT LEAST ONE SCALING FACTOR FOR A FIRST DEPTH MAP

(71) Applicant: ROBERT BOSCH GMBH, Stuttgart (DE)

(72) Inventors: Christopher HERBON, Stuttgart (DE); Istvan NAGY, Stuttgart (DE); Andrei-Vasile IOSIF, Stuttgart (DE)

(21) Appl. No.: 19/005,297

(22) Filed: Dec. 30, 2024

(30) Foreign Application Priority Data
Jan. 12, 2024 (DE) 10 2024 100 899.7

(51) Int. Cl. G06T 7/50

(52) U.S. Cl. CPC G06T 7/50; G06T 2207/20084

(57) ABSTRACT

Method for ascertaining at least one scaling factor for a first depth map (1), said method having the following steps:
a) extracting first depth values (3) d_{1,i} for a plurality of pixels i of the first depth map;
b) ascertaining a comparison depth value (4) d_{2,i} for each first depth value (3) d_{1,i};
c) calculating ratios

$${S}_{r , i} = \frac{{d}_{1 , i}}{{d}_{2 , i}}$$

between the first depth value (3) d_{1,i} and the comparison depth value (4) d_{2,i} for each pixel i;
d) ascertaining a frequency distribution (5) of the ratio S_{r,i} over all pixels i; and
e) determining the at least one scaling factor on the basis of the frequency distribution (5).

### DISCLOSURE OF THE INVENTION

The invention provides a novel method for scaling a plurality of depth maps for subsequent fusion of the depth maps. Depth maps depict depth information in images. “Depth information” here means information relating to how far away distant objects or displayed object surfaces in an image (for example a camera image) are. Depth information can be obtained in various ways, for example by photogrammetry (also called structure from motion), machine learning (also called deep learning), or stereo disparity methods. Depth information relating to an image (for example a camera image) is often obtained using various techniques, such that a plurality of depth maps exist for an image (for example a camera image). In order to fuse these data in a post-processing step, the scale of the depth maps must be aligned. If this is not done, it leads to discontinuities in the resulting fused depth map. Therefore, the present invention shows how to correctly align a plurality of depth maps to enable central fusion.

In this case, the intention is to propose a new method showing how different depth maps can be scaled with respect to one another in order to enable fusion of depth maps and joint data processing of the depth information from different depth maps.

A method for ascertaining at least one scaling factor for a first depth map is described here, said method having the following steps:
a) extracting first depth values d_{1,i} for a plurality of pixels i of the first depth map;
b) ascertaining a comparison depth value d_{2,i} for each first depth value d_{1,i};
c) calculating ratios

$${S}_{r , i} = \frac{{d}_{1 , i}}{{d}_{2 , i}}$$

between the first depth value d_{1,i} and the comparison depth value d_{2,i} for each pixel i;
d) ascertaining a frequency distribution of the ratio S_{r,i} over all pixels i; and
e) determining the at least one scaling factor on the basis of the frequency distribution.

It is particularly preferred if the comparison depth value d_{2,i} was extracted in step b) from a second depth map for a pixel corresponding to the respective pixel i in the first depth map.

The described method is particularly suitable for processing a first depth map and a second depth map together, both depth maps providing depth information for an image of a single camera. The first depth map and the second depth map have preferably been created on the basis of the same camera image using different algorithms and possibly also preferably with the addition of different additional data.

A depth is particularly preferably specified in the depth maps for each image point. The depth describes a distance between the object in the vicinity of the camera and visible in the respective image point or the object described by the image point and the camera. In other words: the depth describes the distance between a scene point and the camera. An image point is a projected 2D point in the image (a pixel). A scene point is a 3D point in the world at a distance from the camera. The distance between the scene point and the camera may relate, for example, to a direct distance from the camera. This thus means that the distance along a viewing direction from the camera to the image point is measured. It is conceivable and also included here, but it is not preferable, for the depth to be defined in each case in relation to a camera plane in which the camera is situated and which has a defined alignment with respect to the camera alignment. Such a camera plane is preferably aligned normal to an axis of the camera.

Various algorithms and methods for creating depth maps for camera images can be applied to different depth maps. Since depth information can regularly be estimated only relatively (that is to say in comparison with other depth information) using customary algorithms, there is regularly different scaling between such depth maps. The method described here is used to describe an algorithm using which it is possible to find a scaling factor which describes this scaling and which thus enables combination of the depth maps.

The method may in principle also be used if the intention is to evaluate depth information or depth maps which have been created on the basis of camera images which originate from different cameras or which have been recorded with a time offset by a single camera.

In addition, it is then necessary to perform a pixel assignment for the various camera images. Otherwise, the comparison of depth information at the pixel level cannot be performed.

An algorithm which creates a depth map provides depth values for each pixel of a single image. Such an algorithm possibly draws additional images which, for example, have been recorded using the same camera beforehand or afterwards in order to generate the depth information of the depth map.

The creation of the first depth map and the creation of the second depth map may differ in that different additional images have been used to create the respective depth map.

In principle, deviations in the scaling of depth maps created from camera images can occur primarily because cameras usually capture images using a monocular optical system. Information captured using a monocular optical system initially has no scale, and an external reference is required in order to obtain depth information. The external reference may possibly be generated using a further movement of the vehicle since the image of the same camera in the camera image shows visible objects from a different perspective if the vehicle is moved further. Camera images recorded beforehand or later by the same camera can thus be used for creating depth maps. Data describing the movement of the vehicle are then also generally required for this purpose. Such additional data can be received, for example, via a bus system of the vehicle and such data can be obtained from the drive train, for example, as navigation data and/or movement data of the vehicle. If appropriate, it is also possible to use data from additional cameras which are attached to the vehicle at a different position or from entirely different sensors, such as, for example, LIDAR or RADAR sensors arranged in the region of the camera, as additional data for the creation of depth maps.

To create depth maps on the basis of camera images using a monocular optical system, filters or neural networks which are generated using deep learning and which can optionally be used in the form of data filters can generally be used particularly efficiently. However, these filters have the fundamental problem that the training data suitable for training such filters can often generate only relative depth information. If an attempt is made with such approaches to obtain absolute depth information, the algorithms are regularly very temperamental with respect to the camera assembly position and they would theoretically have to be completely retrained if a camera assembly position is changed.

In principle, there are many application possibilities for the approach described here to finding a scaling factor for scaling between two depth maps, since cameras with monocular optical systems are widely used.

Here, it is proposed to ascertain a ratio to a comparison depth value for each individual pixel of a depth map, wherein the comparison depth value is preferably a second depth value for a corresponding pixel of a second depth map. This multiplicity of ratios are basically pixel-individual scaling factors which are calculated in step c). This results in a type of scaling factor map which regularly shows different scaling factors distributed over the entire depth map.

Subsequently, a frequency distribution of the ratios ascertained in this way is determined (step d)). Based on this frequency distribution, a global scaling factor (overall scaling factor) is now determined for the entire first depth map in relation to the comparison depth values (in particular in relation to the second depth map). This frequency distribution is evaluated according to step e) in order to determine the scaling factor.

Compared to other approaches in which an overall scaling factor is ascertained directly from the individual depth maps, this approach prevents the particular inaccuracy of the scaling of the individual depth maps from mutually balancing out one another in the determination of the scaling factor and thus falsifying the determination of the scaling factor. The scaling for each individual pixel of the depth map is correct in any case owing to the approach described herein. The frequency distribution makes fluctuations in the scaling factor over the entire depth map visible. The frequency distribution is generally also referred to here as a histogram.

The method is particularly preferred if groups and/or subsets of actual image pixels are in each case considered as pixels i for carrying out the method steps.

The depth values d_{1,i} are then ascertained and the comparison depth values d_{2,i} and the ratios are

$${S}_{r , i} = \frac{{d}_{1 , i}}{{d}_{2 , i}}$$

and then ascertained in each case for these groups of image pixels. By way of example, such a group of image pixels may be defined as n times n image pixels, for example as 5×5 image pixels. In embodiment variants, an average/common depth value d₁ and an average/common comparison depth value d_{2,i} can then first (before carrying out the method steps) be determined for such a group of image pixels, said values then being processed in each case according to the described method.

According to this embodiment variant of the described method, it is possible to reduce the computational outlay for carrying out the described method. In further embodiment variants of the method, it is optionally also possible to take into consideration only a subset of pixels, ideally with the same spatial distribution. If appropriate, each X-th pixel (for example each tenth pixel) or in each case groups of pixels are considered together as one pixel for carrying out the method described here and are examined as one.

The method described herein describes an approach which can also be referred to as “histogram-based” and which can be used to find scaling factors for scaling between depth maps. In the case of ideal data, the ratio which is extracted from a single pixel would be satisfactory. However, a multiplicity of errors can occur in the creation of the depth map, and so statistics about the entire image is the most robust approach.

It is preferred if a so-called Gaussian mixing model is used to determine the scaling factor of the described method. In this way, the superposition of a plurality of Gaussian distributions is used to approximate the histogram. By ascertaining the mean value of the distributions, it is possible to determine the presence of an individual peak value in contrast to a plurality of strong peak values. The standard deviation provides information about the gradient of the curve and thus about the reliability of the estimation.

It is also preferred if the at least one scaling parameter is ascertained in step e) as at least one parameter of a frequency distribution.

A conventional frequency distribution suitable here is, for example, the Gaussian distribution already described further above, which is also referred to as normal distribution. It is preferred if at least one normal distribution which approximates the frequency distribution ascertained in step d) is determined in step e). A normal distribution has various parameters by which it is described, in particular the expected value or the mean value and the variance.

It is further preferred if the at least one scaling parameter is determined as the mean value of the normal distribution.

If the scaling of the two depth maps or of the depth map and of the comparison depth values is in each case uniform, the frequency distribution will correspond to a sharp normal distribution with a high and significant mean value and a narrow standard deviation.

It is also preferred if, in step e), a confidence measure for the determined at least one scaling factor is ascertained from a standard deviation of the normal distribution.

By means of the approach to determining the scaling factor over a normal distribution, a parameter is directly available with the standard deviation, which parameter is well suited as a confidence measure for the scaling factor and can even be used directly for this purpose.

It is additionally preferred if a check is made in step e) to determine whether the frequency distribution has a plurality of extreme values, wherein a plurality of extreme values in step e) is included in an evaluation according to which the accuracy of the depth information of the first depth map and/or of a second depth map is evaluated.

It is furthermore preferred if, in step e), in the case of a frequency distribution with a plurality of extreme values, the frequency distribution is mapped with a plurality of normal distributions.

It is additionally preferred if the at least one scaling factor ascertained in step e) is a relative scaling factor with which the scaling of the first depth values of at least one first depth map is comparable with the scaling of comparison depth values, wherein the method additionally comprises determining an absolute reference scale for depth values of the at least one depth map.

It is also preferred if the absolute reference scale in step e) is determined by converting the absolute reference scale of a comparison depth map with the at least one scaling factor.

It is additionally preferred if the absolute reference scale is ascertained on the basis of at least one of the following approaches:
ascertaining a calibrated base width of two cameras using which the first depth map was created by means of a stereo disparity method;
using size references within the first depth map;
analysing the at least one first depth map using a neural network to ascertain an absolute reference scale.

The main application possibility of the approach presented here is depth map fusion. A depth map fusion algorithm may be applied once the depth maps have been appropriately scaled.

The method described here enables the fusion of different depth maps which are obtained by photogrammetry. These depth maps are obtained by image pairs with different time intervals, which means that the optical flow is calculated for images with different time intervals from the current image.

In connection with photogrammetric methods, dynamic objects, low ego vehicle speeds, occlusions and repeating structures reduce the quality of the depth map. Therefore, the use of filters with neural networks is desirable, which in principle could enable automatic minimization of such influences.

The fusion of these depth maps leads to a considerable improvement in the performance of geometric computer vision algorithms, such as, for example: local surface normals, road surface estimation and recognition of objects at a low height.

In addition, the relative scaling applications are not limited to the fusion of depth maps. The technique of relative scaling presented may also be used for evaluation purposes when a depth map is available as a true reference (“ground truth”). The true reference (“ground truth”) may be obtained, for example, from LIDAR or stereo data, and the evaluated depth map may be a depth map obtained from mono by photogrammetry or depth. Consequently, in addition to a trivial pixel-by-pixel depth value comparison, the scale difference is also evaluated.

The intention here is likewise to describe an apparatus for data processing comprising a processor adapted/configured to carry out the described method.

The apparatus may be in particular a control device and/or a module within an overall system of a motor vehicle, which is configured to carry out highly automated and possibly even autonomous driving functions. The depth maps processed by the method have preferably been created on the basis of sensor data (in particular on the basis of camera data) processed using the overall system to provide parameters and/or control variables for providing the highly automated driving function.

The intention is likewise to claim a computer program product comprising commands which, when the computer program product is executed by a computer, cause said computer to execute the described method.

The intention is likewise to describe a computer-readable storage medium comprising commands which, when executed by a computer, cause said computer to execute the described method.

The invention and the technical field of the invention are explained in more detail below on the basis of the figures. The figures show preferred exemplary embodiments to which the invention is not restricted. It should be pointed out in particular that the figures and in particular the size ratios illustrated in the figures are purely schematic. In the figures:

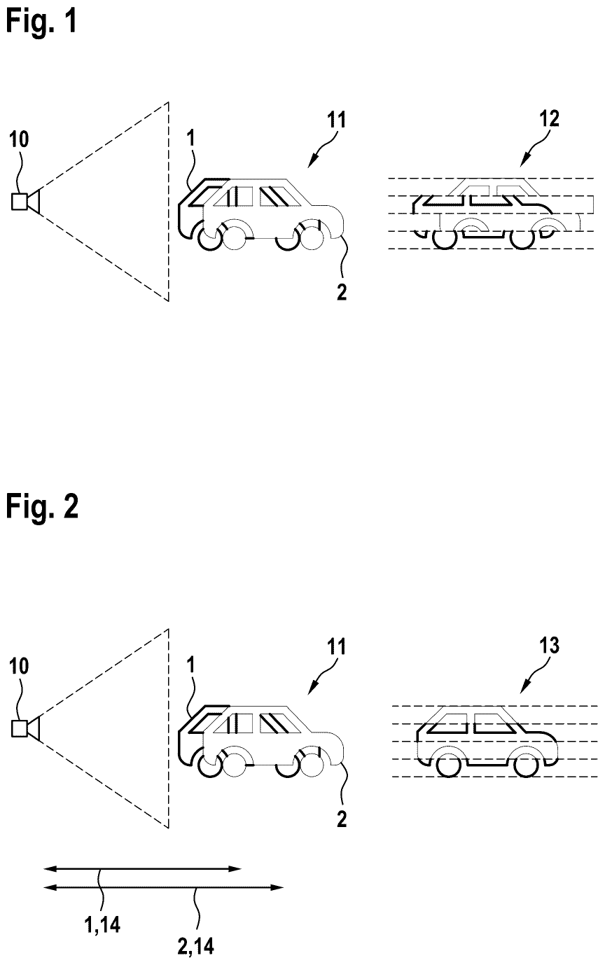

FIG. 1: schematically shows an inconsistent fusion of depth maps;

FIG. 2: schematically shows a fusion of depth maps which has been carried out with the aid of the method described here;

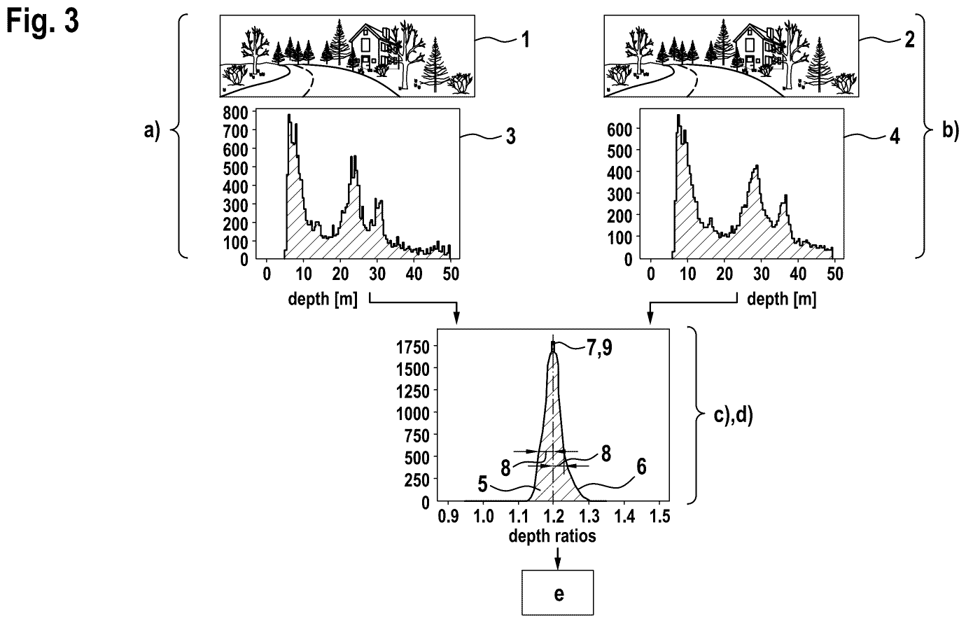

FIG. 3: shows a flowchart of the described method; and

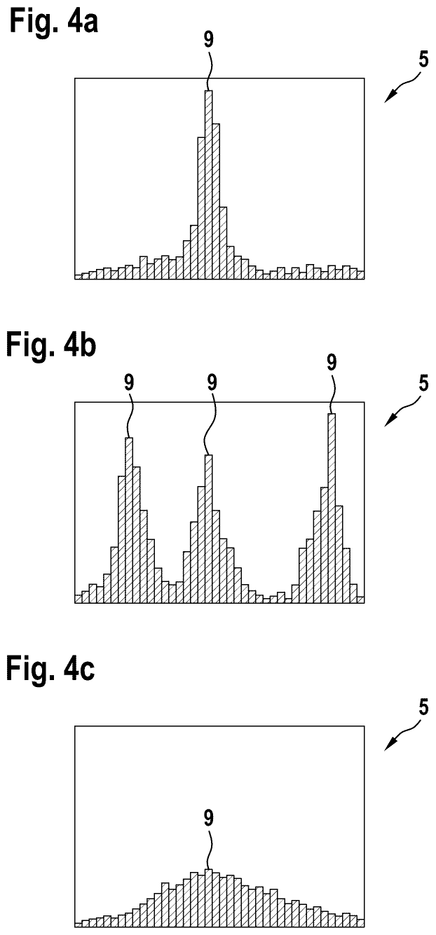

FIGS. 4a to 4c: show various frequency distributions which can be examined within the scope of the described method.

FIG. 1 shows an example of depth maps 11 which are displaced or scaled differently with respect to one another and which have been created using a camera 10, wherein different algorithms for creating the depth map from raw camera data have possibly been used. If appropriate, the two depth maps 11 which are displaced with respect to one another may also have been generated with different raw data. FIG. 2 further shows the result of an inconsistent fused depth map 12. Reliable information cannot regularly be obtained from such an inconsistent fused depth map 12.

In comparison thereto, FIG. 2 shows an example according to which the two depth maps 11 which are displaced with respect to one another or scaled differently have been fused to form a scaled fused depth map 13 with the aid of the method described here. By way of example, scaling scales 14 of the first depth map 1 and of the second depth map 2 are plotted in the lower region of FIG. 2. If at least one suitable scaling scale 14 has been ascertained amongst these scaling scales 14 using the described method, the two differently scaled depth maps 11 can be fused to form a scaled fused depth map 13 from which reliable information can be obtained.

FIG. 3 schematically shows a flowchart of the described method. A first depth map 1 from which first depth values 3 can be extracted can be seen at the top. It is also possible to identify a second depth map 2 from which second depth values 4 can be ascertained, said second depth values being intended to be used here as comparison depth values in the sense of the described method. This corresponds to steps a) and b) of the described method. Subsequently, a frequency distribution 5 of the ratios

$${S}_{r , i} = \frac{{d}_{1 , i}}{{d}_{2 , i}}$$

between the first dept value 3 d_{1,i} and the comparison depth value d_{2,i} for each pixel i is illustrated. The ratios

$${S}_{r , i} = \frac{{d}_{1 , i}}{{d}_{2 , i}}$$

are calculated according to step c) and the frequency distribution 5 is ascertained according to step d). The scaling factor is preferably determined on the basis of statistical parameters of said frequency distribution 5. The approximation of the frequency distribution 5 with a normal distribution 6 is particularly suitable, such that the scaling factor can be assumed to be the mean value 7 of the normal distribution 6. A standard deviation 8 of the normal distribution 6 can possibly be output as a confidence measure of the determined scaling factor.

FIG. 4a to FIG. 4c now show different forms of frequency distributions 5, which can be examined within the scope of the described method. FIG. 4a shows a frequency distribution 5 with a clearly pronounced extreme value 9 of the frequency, which can be approximated very well with a normal distribution 6 and enables reliable determination of a scaling factor.

FIG. 4b shows a situation with a plurality of peaks/extreme values 9 of the frequency at a similar height. This indicates that consistent fusion may not be possible. Such cases may occur when the depth reconstruction into an algorithm for adding depth information in a camera image has not worked as expected. Such a configuration is an error which is very difficult to rectify since a plurality of equivalent solutions exist or the depth information in different regions of the depth map 1, 2 can also be scaled differently. If necessary, such a situation may be taken as a cause to reject a depth map 1, 2 for further processing.

FIG. 4c shows a further situation which is an indication of a compromised impaired quality of at least one depth map 1, 2. An extreme value 9 is only very weakly pronounced in this case. The described method could be used here to ascertain a low confidence of a scaling factor on the basis of a standard deviation. Such a situation may indicate that the relative scale of a camera 10 used to create the depth map 1, 2 is not well defined. Such an effect may arise from rolling shutter effects, motion blurring or low accuracy of the depth reconstruction (possibly due to poor quality of the optical flow).

1. Method for ascertaining at least one scaling factor for a first depth map, said method having the following steps:
a) extracting first depth values d_{1,i} for a plurality of pixels i of the first depth map;
b) ascertaining a comparison depth value d_{2,i} for each first depth value d_{1,i};
c) calculating ratios
$${S}_{r , i} = \frac{{d}_{1 , i}}{{d}_{2 , i}}$$
between the first depth value d_{1,i} and the comparison depth value d_{2,i} for each pixel i;
d) ascertaining a frequency distribution of the ratio S_{r,i} over all pixels i; and
e) determining the at least one scaling factor on the basis of the frequency distribution.

2. Method according to claim 1, wherein the comparison depth value d_{2,i} was extracted in step b) from a second depth map for a pixel corresponding to the respective pixel i in the first depth map.

3. Method according to claim 1, wherein groups and/or subsets of actual image pixels are in each case considered as pixels i for carrying out the method steps.

4. Method according to claim 1, wherein the at least one scaling parameter is ascertained in step e) as at least one parameter of at least one frequency distribution.

5. Method according to claim 4, wherein the at least one scaling parameter is determined on the basis of at least one mean value of the at least one normal distribution.

6. Method according to claim 5, wherein, in step e), a confidence measure for the determined at least one scaling factor is ascertained from a standard deviation of the at least one normal distribution.

7. Method according to claim 1, wherein a check is made in step e) to determine whether the frequency distribution has a plurality of extreme values, wherein a plurality of extreme values in step e) is included in an evaluation according to which the accuracy of the depth information of the first depth map and/or of a second depth map is evaluated.

8. Method according to claim 7, wherein, in step e), in the case of a frequency distribution with a plurality of extreme values, the frequency distribution is simulated with a plurality of normal distributions.

9. Method according to claim 1, wherein the at least one scaling factor ascertained in step e) is a relative scaling factor with which the scaling of the first depth values of at least one first depth map is comparable with the scaling of comparison depth values, wherein the method additionally comprises determining an absolute reference scale for depth values of the at least one depth map.

10. Method according to claim 9, wherein the absolute reference scale in step e) is determined by converting the absolute reference scale of a comparison depth map with the at least one scaling factor.

11. Method according to claim 9, wherein the absolute reference scale is ascertained on the basis of at least one of the following approaches:
ascertaining a calibrated base width of two cameras using which the first depth map was created by means of a stereo disparity method;
using size references within the first depth map;
analysing the at least one first depth map using a neural network to ascertain an absolute reference scale.

12. Apparatus for data processing, comprising a processor adapted/configured to execute the method according to claim 1.

13. Computer program product comprising commands which, when the computer program product is executed by a computer, cause said computer to execute the method according to claim 1.

14. Computer-readable storage medium comprising commands which, when executed by a computer, cause said computer to execute the method according to claim 1.
